(19) United States
(12) Patent Application Publication
(10) Pub. No.: US 2009/0009420 A1
(43) Pub. Date: Jan. 8, 2009

(54) COMBINATION OF PORTABLE COMPUTER AND ANTENNA DEVICE

(76) Inventors: Chang-Tai HSIEH, Taipei (TW); Hui-Ju Tsai, Taipei (TW)

Correspondence Address: HDSL, P.O. BOX 220746, CHANTILLY, VA, 20153-0746, US

(21) Appl. No.: 11/773,058

(22) Filed: Jul. 3, 2007

(51) Int. Cl. H01Q 1/22; H01Q 1/38; H01Q 1/42

(52) U.S. Cl. 343/872; 343/878

(57) ABSTRACT

A combination of a portable computer and an antenna device includes a portable computer and an antenna device. The top of a screen casing of the portable computer has a plurality of positioning troughs. One side of the casing of the portable computer has an accommodating trough. The antenna device is formed into a sheet-like shape and is accommodated in the accommodating trough. The bottom of the antenna device is provided with a positioning seat. Both sides of the positioning seat have a fixing rod respectively that extends outwardly. The fixing rods and the positioning seat are inserted into the positioning trough. The antenna device is electrically connected with the portable computer, so that the portable computer can receive and transmit the wireless signals via the antenna device.

### BACKGROUND OF THE INVENTION

1. Field of the Invention

The present invention relates to an antenna, and in particular to an antenna that can be connected on a portable computer.

2. Description of Prior Art

The development of the wireless technology breaks a lot of limitations in the traditional cable transmission of signals, such as the type and range of the signal transmission. Although the wireless technology is limited to voice transmission at earlier stage, with the promotion of novel techniques and components, the wireless technology is gradually applied to other applications. Especially, once the Internet technology cooperates with a portable computer, the capability of the Internet has been brought to a nearly boundless extent.

Although the hardware of the computer has developed to a fairly matured stage in the past, with the promotion of novel techniques and applications, the traditional computer has to be provided with additional hardware for support. For example, the wireless technology is used to access the Internet.

Since the conventional portable computer is not provided with an antenna device for receiving the wireless signals, an additional antenna device should be provided to access the Internet via the wireless technology. Such an external antenna device is electrically connected with the portable computer via a USB port, so that the portable can receive and transmit the wireless signals via the antenna device. However, it is necessary for the user to carry an additional antenna device so as to access the wireless Internet resource. Without the antenna device, the portable computer cannot receive any signals. Further, another drawback of the reception antenna lies in that it occupies a USB port inevitably and thus may become a trouble if the user needs more USB ports.

The later-developed portable computer is designed to offer an antenna device for receiving the wireless signals by additionally providing a built-in antenna in the computer casing. Although this solution can solve the inconvenience of the conventional external antenna device and does not occupy an additional connecting port, the angle of such kind of built-in antenna cannot be adjusted independently when the reception of signals is not good. Therefore, the user has to adjust the position of the portable computer so as to receive the wireless signals completely. Therefore, it is an important issue for those skilled in this art to overcome the drawbacks of the above-mentioned portable computer and the antenna device.

### SUMMARY OF THE INVENTION

In view of the above drawbacks, the present invention is to provide a combination of a portable computer and an antenna device that can receive and transmit wireless signals. By changing the structure of the antenna device into the profile of a standard PCMCIA card, the antenna device is easy to be accommodated in a slot for the original PCMCIA card of the portable computer. In addition to the convenience in carrying, the antenna device can be electrically connected with the portable computer at the preset connecting position. In this way, the user can receive the wireless signals at different places.

The present invention provides a combination of a portable computer and an antenna device, which includes a portable computer and an antenna device. The top of a screen casing of the portable computer has a plurality of positioning troughs. One side of the casing of the portable computer has an accommodating trough. The antenna device is formed into a sheet-like shape, and is accommodated in the accommodating trough. The bottom of the antenna device is provided with a positioning seat. Both sides of the positioning seat have a fixing rod respectively that extends outwardly. The fixing rods and the positioning seat are inserted into the positioning troughs. The antenna device is electrically connected with the portable computer, so that the portable computer can receive and transmit the wireless signals via the antenna device.

### BRIEF DESCRIPTION OF THE DRAWINGS

FIG. 1 is a perspective view showing the structure of the present invention;

FIG. 2 is an exploded perspective view showing the structure of the antenna device of the present invention;

FIG. 3 is a schematic view showing the operation of the present invention; and

FIG. 4 is a schematic view showing another operation of the present invention.

### DETAILED DESCRIPTION OF THE INVENTION

The technical contents of the present invention will be described with reference to the accompanying drawings.

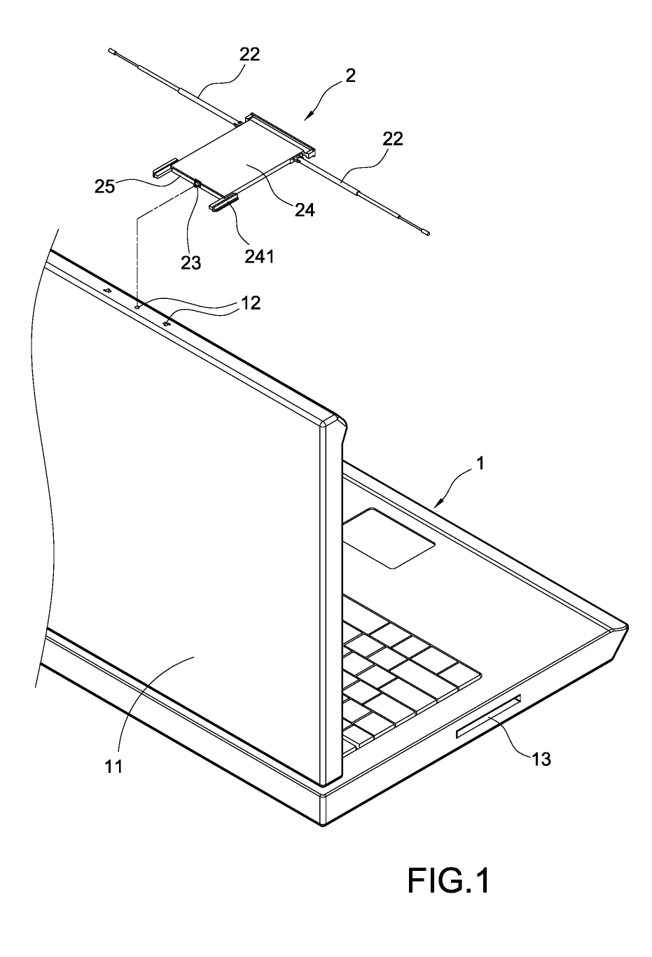

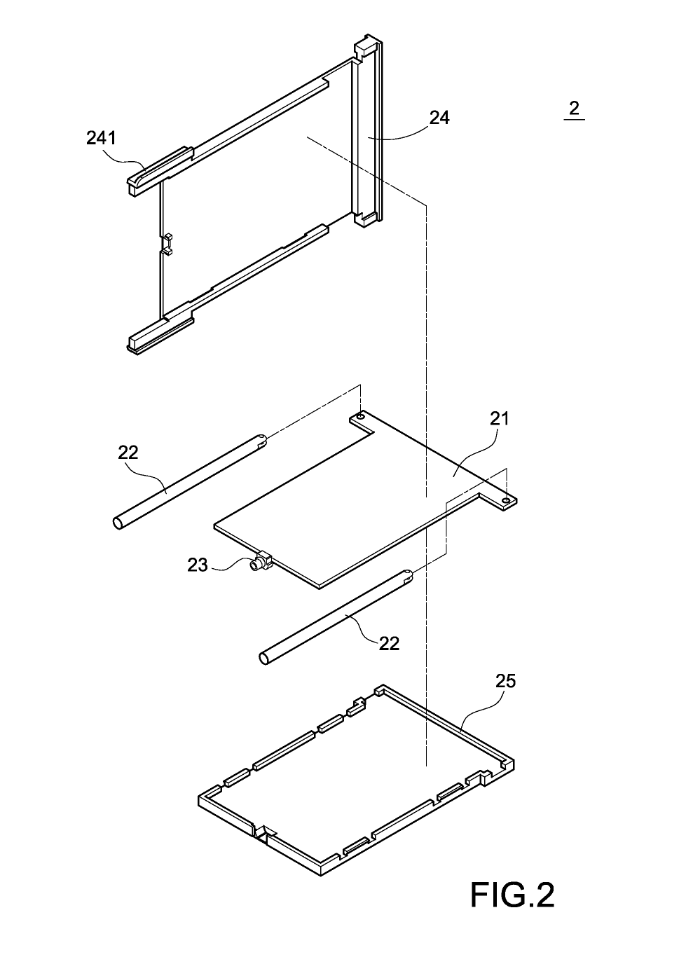

With reference to FIG. 1, it is a perspective view showing the structure of the present invention. As shown in this figure, the combination structure of the present invention includes a portable computer 1 and an antenna device 2. The antenna device 2 is connected on the portable computer 1. The portable computer 1 has a screen 11. The top of the casing of the screen 11 is provided with a plurality of positioning troughs 12. One side of the casing of the portable computer 1 has an accommodating trough 13. The accommodating trough 13 is a slot for a standard PCMCIA card. The profile of the antenna device 2 is formed into a sheet-like shape, and can be exactly accommodated in the accommodating trough 13, as shown in the exploded view of the antenna device in FIG. 2. In the present embodiment, the antenna device is used to receive television signals. The antenna device 2 has a substrate 21 formed into a T-lettered shape. The substrate 21 is provided thereon with a plurality of electronic elements that form a receiving and transmitting region, thereby having a function of receiving or transmitting signals. Plates that protrude from both sides of the substrate 21 are pivotally connected with a rod-like antenna 22 respectively. The rod-like antenna 22 is electrically connected with the substrate 21. Further, the rod-like antenna 22 is telescopic, and the elevation angle of the rod-like antenna 22 can be adjusted up to 180 degrees. The bottom of the substrate 21 is provided with a positioning seat 23. The positioning seat 23 is electrically connected with the substrate 21. The antenna device 2 further includes an upper casing 24 and a lower casing 25. The upper casing 24 and the lower casing 25 are connected with other so as to cover the substrate 21 therein. The plurality of rod-like antennas 22 on the substrate 21 and the positioning seat 23 on the bottom of the substrate are exposed to the outside. A fixing rod 241 extends from each side of the bottom of the upper casing 24, so that the length of the antenna device 2 is substantially identical to that of the accommodating trough 13. The fixing rods 241 and the positioning seat 23 protruding from the substrate 21 are inserted collectively onto the positioning troughs 12 of the casing of the portable computer 1. In this way, the antenna device 2 can be fixed on the portable computer 1. Further, the antenna device 2 can be electrically connected with the portable computer 1 via the positioning seat 23.

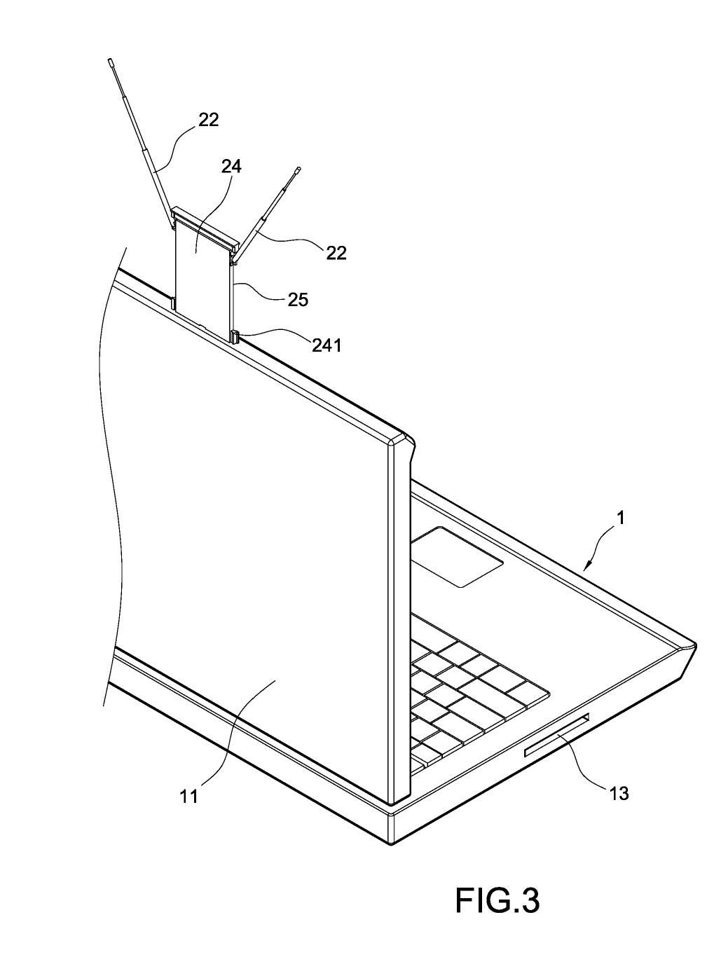

With reference to FIG. 3, it is a schematic view showing the operation of the present invention. As shown in this figure, after the positioning seat 23 on the bottom and the fixing rods 241 on both sides of the positioning seat 23 are inserted into the positioning troughs 12 of the casing of the portable computer 1, the antenna device 2 is electrically connected with the interior of the portable computer 1 via the positioning seat 23. Therefore, the signals received by the antenna device 2 can be transmitted into the portable computer 1. Further, the rod-like antennas 22 on both sides of the antenna device 2 can extend the length thereof, thereby increasing the range and intensity of the wireless signals received by the antenna device 2.

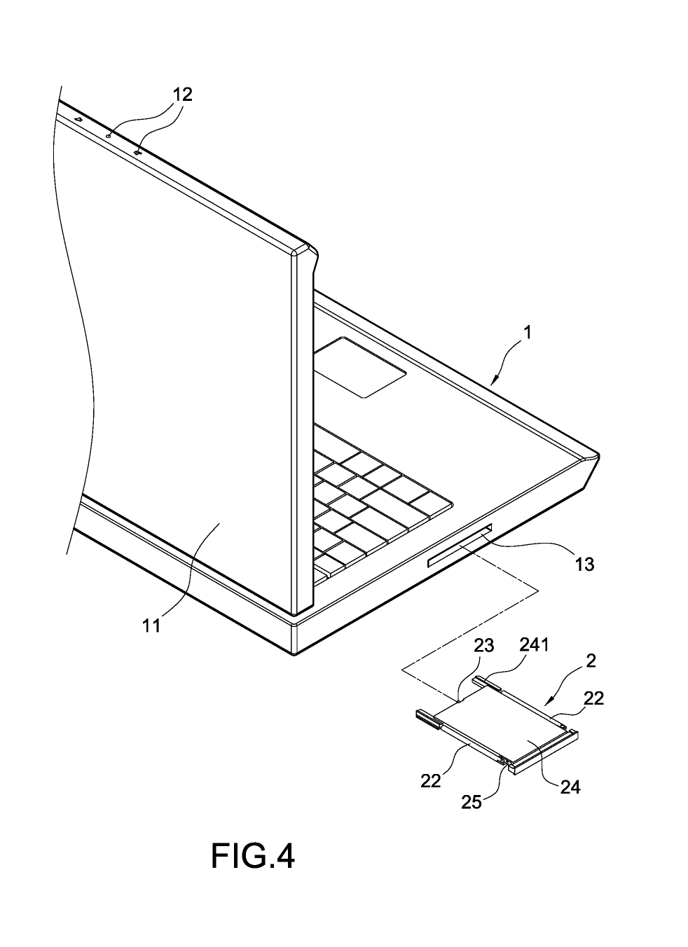

With reference to FIG. 4, it is a schematic view showing another operation of the present invention. As shown in this figure, when the antenna device 2 is not in use, it can be inserted and accommodated in the accommodating trough 13 of the portable computer 1. The antenna device 2 can simulate the profile of the PCMCIA with the fixing rods 241 extending from both sides of the bottom, so that the antenna device 2 can be exactly locked into the accommodating trough 13. As a result, the antenna device 2 can move with the portable computer 1.

Although the present invention has been described with reference to the foregoing preferred embodiment, it will be understood that the invention is not limited to the details thereof. Various equivalent variations and modifications may still occur to those skilled in this art in view of the teachings of the present invention. Thus, all such variations and equivalent modifications are also embraced within the scope of the invention as defined in the appended claims.

What is claimed is:

1. A combination of a portable computer and an antenna device, comprising:
the portable computer, one side of a casing of the computer having an accommodating trough, one side of a screen casing of the computer being provided with a plurality of positioning troughs; and
the antenna device detachably connected into the accommodating trough, a bottom of the antenna device having a positioning seat, both sides of the positioning seat being provided with a fixing rod respectively;
wherein after the antenna device is removed from the accommodating trough, with the positioning seat and the fixing rods being inserted in the positioning troughs, the antenna device is fixed on the portable computer and thus is electrically connected with the portable computer via the positioning seat.

2. The combination of a portable computer and an antenna device according to claim 1, wherein the accommodating trough is a slot for a PCMCIA card.

3. The combination of a portable computer and an antenna device according to claim 1, wherein the antenna device is formed into a sheet-like shape.

4. The combination of a portable computer and an antenna device according to claim 3, wherein the antenna device further includes a substrate, an upper casing and a lower casing, the upper casing and the lower casing are connected with each other so as to cover the substrate therein.

5. The combination of a portable computer and an antenna device according to claim 4, wherein the substrate is formed into a T-lettered shape.

6. The combination of a portable computer and an antenna device according to claim 4, wherein both sides of the substrate are pivotally connected with a rod-like antenna respectively, thereby widening the intensity and range of the antenna for receiving signals.

7. The combination of a portable computer and an antenna device according to claim 6, wherein the rod-like antenna is telescopic.

8. The combination of a portable computer and an antenna device according to claim 4, wherein the positioning seat is electrically connected with the substrate.

9. The combination of a portable computer and an antenna device according to claim 1, wherein the antenna device is a television antenna.
